(19) United States
(12) Patent Application Publication
(10) Pub. No.: US 2004/0040903 A1
(43) Pub. Date: Mar. 4, 2004

(54) Grease trap filter and grease removal system

(76) Inventors: Andrew Burke, Marietta, GA (US); Michael Zweber, New Prague, MN (US)

Correspondence Address: PIPER RUDNICK, P.O. Box 64807, Chicago, IL, 60664-0807, US

(21) Appl. No.: 10/231,740

(22) Filed: Aug. 30, 2002

(51) Int. Cl. B01D 36/04

(52) U.S. Cl. 210/172; 210/323.2; 210/416.5; 210/460; 210/497.01; 210/500.1

(57) ABSTRACT

A grease trap filter and grease removal system includes a filter with a horizontal strainer tube and a vertical strainer tube. An elbow connects the cylindrical horizontal and vertical strainer tubes in a generally perpendicular fashion. The filter is removably positioned within a grease trap so that the horizontal strainer tube rests on a bottom of the grease trap and the vertical strainer tube is positioned adjacent an end wall of the grease trap. The wand of a suction device is temporarily placed in communication with an opening formed in the vertical strainer tube of the filter to draw grease through the filter and remove it from the grease trap.

### TECHNICAL FIELD OF THE INVENTION

The present invention relates in general to the field of cooking equipment, and, more particularly, to a filter and system for effective removal of waste grease from a grease trap.

### BACKGROUND OF THE INVENTION

In the restaurant industry, grill stations used for the preparation of food products typically include holding reservoirs, commonly known as grill grease traps. These grease traps contain used remains from cooking, including in particular waste grease (beef tallow), along with solid particles. The solid particles may include meat, egg, starch or other food particles, or carbon residue that may have been scraped from the grill cooking surface. Disposal of the waste grease and solid particles that accumulate in the grease traps has been a longstanding problem for restaurants. It is environmentally harmful to dispose of the waste grease into a drain or garbage container. For this reason, rendering containers are used to dispose of the grease. Traditionally, restaurant employees would empty the waste grease in buckets. The employees would then manually carry the buckets to the back parking lot of the restaurant, where the waste grease would be poured into the rendering tank.

Previous devices have been directed to the filtering and removal of oil from fryers, usually for recycling, and therefore these devices have not addressed the problem of removing and filtering waste grease. One such device, disclosed in U.S. Pat. No. 5,609,193 to Steckler, “Automated Container for Waste Grease,” is directed to the removal of spent fryer grease from a fryer for recycling. Steckler shows a tank with liquid level sensors. A stationary pump equipped with a filter periodically transfers a portion of the spent fryer grease from a fryer to the tank. When the liquid level sensors indicate that the tank has accumulated a predetermined level of spent fryer grease, a truck is coupled to the tank for removal of the grease. The container there disclosed removes the need for a back parking lot rendering tank. However, the device does not replace the manual task of removing and disposing of waste grease from grill station grease traps. For removal and transport of waste grease, the grease trap typically has to be removed from the grill station. Spillage of waste grease is a common problem, resulting in hazardous work conditions, as well as added cleanup time to remove the spilled waste grease. In addition, as waste grease cools, it solidifies, creating additional difficulties for the removal of the grease from the grease trap. A way to more effectively remove waste grease to a waste storage container is desired.

Another prior device directed to removal and recycling of oil is disclosed in U.S. Pat. No. 4,113,623, to Koether et al. The Koether et al. patent discloses a filter apparatus using an inlet/outlet hose which transports used oil from a fryer through a two-way pump to a holding tank. When it is desired to return the oil to the fryer, the pump motor is reversed, drawing the used oil through a disposable filter bag that has been submersed in the used cooking oil in the holding tank. The (filtered) oil is returned through the pump and to the fryer. If the filter becomes clogged due, for example, to the hardening of oil or grease that has cooled, the filter must be disconnected, removed from the holding tank and cleaned or replaced.

U.S. Pat. No. 4,702,827, to Wenzel, discloses a portable filter device for filtering solid material from a reusable cooking medium (oil) and returning the filtered oil to a fryer. The portable filter device uses a reversible pump to draw the oil into a storage container. To return the oil to the fryer, the pump motor is reversed, drawing the return oil through a filter, which removes solid particles from the return oil and delivers the oil to the fryer. If solid oils are present in the return oil, a wrap around heater, present in the return plumbing, may be activated to melt the solids. Because the device disclosed in Wenzel is designed for filtering oil from a fryer, the device requires the use of a holding container, and the device only filters and heats the oil upon returning it to the fryer. Because of this, the portable filter of Wenzel is prone to clogs from waste grease entering the device, and it is difficult to clean.

Accordingly, it is an object of the present invention to provide a system for filtering grease prior to removal from the grease trap.

It is another object of the present invention to provide a system for efficiently and effectively removing grease from a grease trap.

It is another object of the present invention to provide a grease trap filter and grease removal system that is easy to operate and use.

It is still another object of the present invention to provide a grease trap filter that is easily cleaned and replaced.

### SUMMARY OF THE INVENTION

A grease trap filter and grease removal system is provided for separating food particles from the grease in a grease trap. The filter includes a horizontal strainer tube and a vertical strainer tube. An elbow connects the two cylindrical strainer tubes together in a generally perpendicular fashion. The filter is removably positioned within a grease trap such that the horizontal strainer tube rests on a bottom of the grease trap with the vertical strainer tube positioned adjacent an end wall, preferably the front wall, of the grease trap.

A suction device is used in combination with the filter to filter and remove grease from the grease trap. The suction device includes a pump with an inlet and an outlet. An intake assembly is connected to the inlet of the pump. The intake assembly includes a hose that is equipped with a wand for removing grease from the grease trap. The filter positioned in the grease trap includes an opening in its vertical strainer tube that may be engaged by the wand of the suction device. The wand and hose of the intake assembly guide the grease from the grease trap to the pump when the suction device is activated for disposing the waste grease in a waste storage container.

For a more complete understanding of the nature and scope of the invention, reference may now be had to the following detailed description of embodiments taken thereof in conjunction with the appended claims and accompanying drawings.

### BRIEF DESCRIPTION OF THE DRAWINGS

Further aspects of the invention and their advantages may be discerned from the following description when taken in conjunction with the drawings, in which like characters number like parts and in which:

FIG. 1 is a perspective view of a standard restaurant grill with a grease trap secured to the side of the grill;

FIG. 2 is a perspective exploded and enlarged view of the grease trap of FIG. 1 with the filter of an embodiment of the present invention;

FIG. 3 is a side view of the filter and grease trap of FIG. 2 in the assembled configuration with the latter illustrated in phantom;

FIG. 4 is a perspective view of a suction device with the intake assembly and cover removed, suitable for use with the filter of FIGS. 2 and 3 in an embodiment of the present invention; and

FIG. 5 is a side view of the intake assembly of the suction device of FIG. 4.

### DETAILED DESCRIPTION OF ILLUSTRATED EMBODIMENT

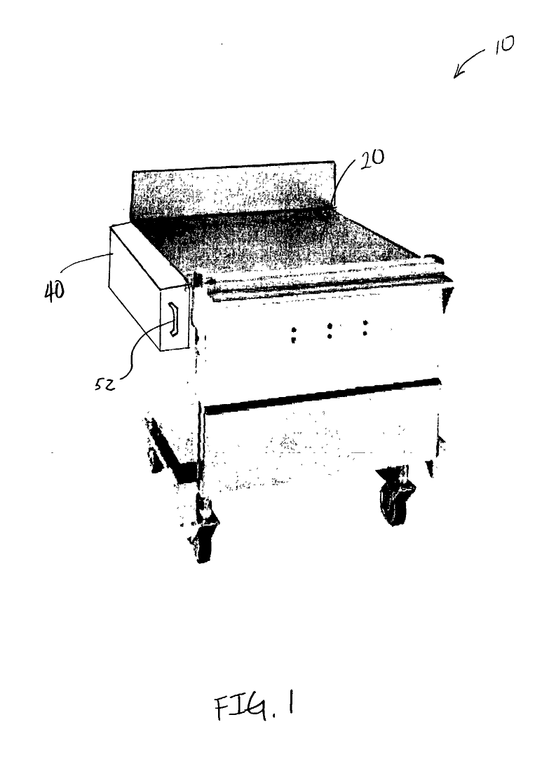

FIG. 1 illustrates a typical restaurant grill, indicated in general at 10, with a grease trap 40 positioned on the side of the grill. The grill has a stainless steal cooking surface 20 that is angled downward towards the grease trap 40. Thus, any grease that develops while using the grill will drip off of the edge of the cooking surface 20 into the grease trap 40. Also, the food and grease remaining on the cooking surface 20 of the grill is typically scraped into the grease trap 40 by the cook using a spatula or the like. The grease and the solid waste particles are collected within the grease trap and stored until disposal.

The grease trap 40 may be removed from the side of the grill. Typically, as is known in the art, the grease trap is slid onto a connector track positioned on the side of the grill (not shown). This enables the grease trap 40 to be easily removed from or installed to the side of the grill. Although the illustrated grill includes a single grease trap, the grill may be designed to receive multiple grease traps on any side of the grill. The grease traps may also be containers formed in various shapes and sizes, the latter depending on the size of the cooking surface of the grill.

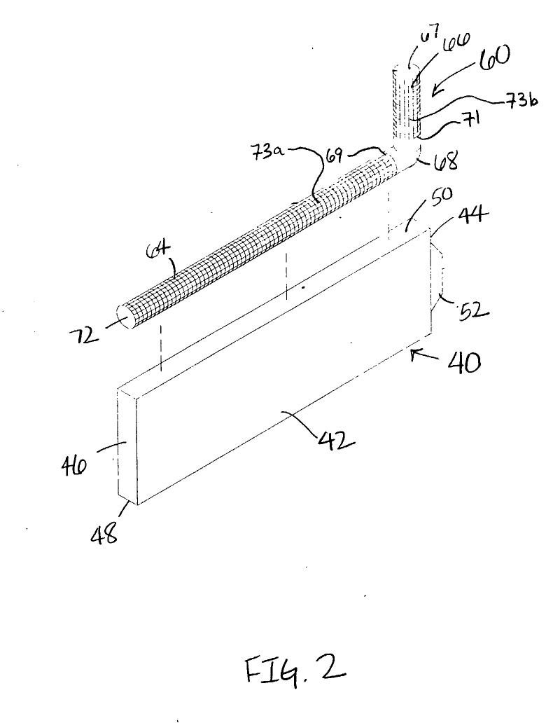

FIG. 2 illustrates an enlarged view of the grease trap of FIG. 2 along with a grease trap filter of an embodiment of the present invention. The grease trap 40 is a rectangular container with sides 42, a front wall 44, a back wall 46 and a bottom surface 48. The grease trap 40 also has an opening 50 at the top of the grease trap that extends the length of the container. The grease trap 40 also includes a handle 52. The handle 52 is grasped by an individual when sliding it into or out of the connector track on the side of the grill. Typically the grease trap has a length of less than 3 feet, a height of approximately 6 inches and a width of approximately 1½ to 2 inches.

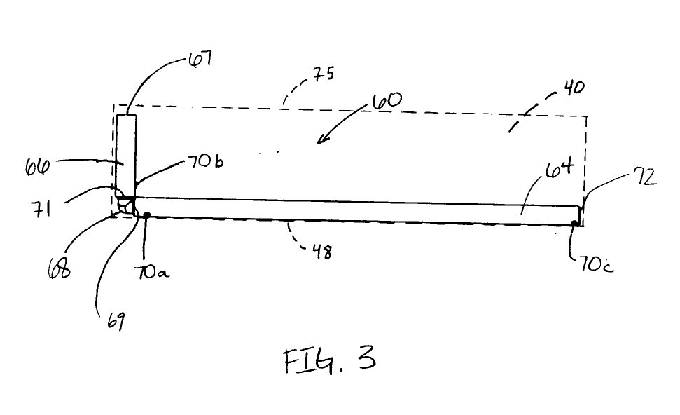

As indicated by FIG. 3 and the dashed lines in FIG. 2, the grease trap filter, indicated in general at 60, is sized to be received within the grease trap 40. As shown in FIGS. 2 and 3, the filter 60 includes a horizontal strainer tube 64 and a vertical strainer tube 66. In the illustrated embodiment, the strainer tubes each have an inner diameter of ⅞ inch. However, the inner diameters of the strainer tubes preferably may range from ⅞ inch to 1½ inches depending on the width of the grease trap 40.

For the dimensions given above for the grease trap 40, the horizontal strainer tube 64 is preferably approximately 27 inches long and the vertical strainer tube 66 is preferably approximately 5 inches long. Clearly, however, the length of the horizontal and vertical strainer tubes may vary depending on the length and height of the grease trap 40.

As illustrated in FIGS. 2 and 3, the horizontal strainer tube 64 is connected to the vertical strainer tube 66 by an elbow 68. The elbow 68 aligns the horizontal strainer tube 64 and the vertical strainer tube 66 so that the tubes are generally perpendicular to each other and in communication with one another. For the dimensions given for the strainer tubes, the elbow 68 preferably has an outer diameter of ⅞ inch at its ends. As a result, the ends of the elbow 68 may be inserted into end 69 of the horizontal strainer tube 64 and the end 71 of the vertical strainer tube 66.

As illustrated in FIG. 3, fasteners 70a and 70b, such as a rivet or the like, are inserted through the horizontal strainer tube 64 near end 69 and through the vertical strainer tube 66 near end 71, respectively, to secure the elbow 68 to the horizontal and vertical strainer tubes. The end of the vertical strainer tube 66 opposite end 71 (and elbow 68) defines an opening 67. As discussed below, the opening 67 is sized to receive a wand from a grease removal suction device to remove the grease from the grease trap.

The end of the horizontal strainer tube 64 opposite end 69 (and elbow 68) is closed with a cap 72. The cap preferably has an outer diameter of approximately ⅞ inches (for the horizontal strainer tube diameter illustrated) so that is fits within the open end of the horizontal strainer tube 64. As illustrated in FIG. 3, a fastener 70c, such as a rivet or the like, also secures the cap 72 to the horizontal strainer tube.

As shown in FIG. 2, the strainer tubes are formed from a screen that has a plurality of small openings or apertures 73a and 73b. The screen preferably is made from polyethylene, or another material that can withstand hot grease, including, but not limited to, metal screening. The strainer tubes may either be molded as screened cylinders or, alternatively, polyethylene screen sheets, which are somewhat flexible, may be rolled into cylinders and secured to form the strainer tubes. The elbow 68 is also preferably formed from polyethylene or some other plastic that can withstand hot grease, as is the cap 72. It should be noted that while the strainer tubes are illustrated as cylindrical, they could take on a variety of other shapes with a variety of cross sections, such as square, rectangular, triangular, octagonal, etc. In addition, the term “tube” is understood to include any type of enclosed structure including, but not limited to, a box-like or spherical structure.

In use, the filter 60 is positioned within the grease trap 40 as illustrated by FIG. 3 and the dashed lines in FIG. 2. Once inserted into the grease trap 40, the strainer tubes may slightly contact one side of the grease trap 40. Preferably, the strainer tubes are designed to have a diameter that is ⅛ inch to ¼ inch less than the width of the grease trap 40.

As illustrated in FIG. 3, the horizontal strainer tube 64 rests on the bottom 48 of the grease trap while the vertical strainer tube 66 extends upwards along one end of the grease trap 40, preferably the front wall 44. The opening 67 of the filter may either extend slightly above the top edge of the grease trap 75 or, as illustrated in FIG. 3, may be positioned slightly below it.

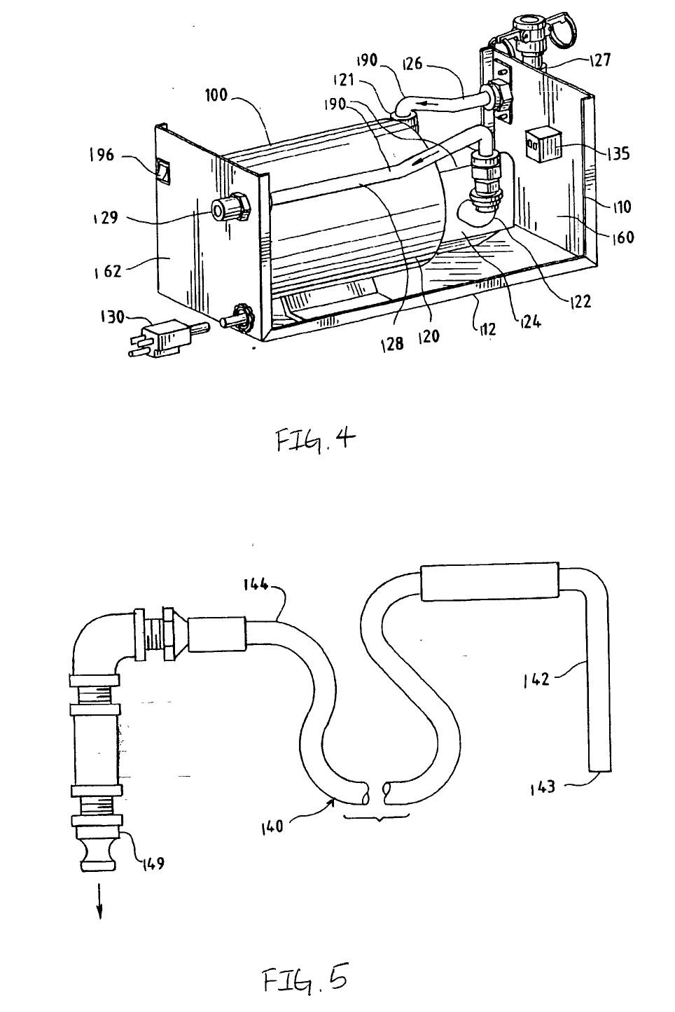

To remove the grease from the grease trap, a device is used similar to the device taught in commonly owned U.S. Pat. No. 6,365,046 to Burke, which is herein incorporated by reference. The device 100 used to remove the grease from the grease trap is illustrated in FIG. 4 and the intake assembly 140 is illustrated in FIG. 5.

The waste grease removal suction device 100 features components that are enclosed in an outer container 110 for protection. The outer container 110 comprises an outer enclosure base 112 and a cover (not shown). In addition to providing protection of the inner components of the suction device, the outer container retains heat within the enclosed components of the suction device. The outer enclosure base 112 contains first and second end walls 160, 162.

The suction device requires the use of a pump 120, typically an electric vacuum pump, for the removal of waste grease from the grease trap (40 in FIGS. 1-3). Preferably, the pump 120 is mounted to and housed within the outer container 110. The pump 120 contains an inlet 121 and an outlet 122, preferably at the head 124 of the pump. In one embodiment, a Viking Pump Company model #L-510-4852-502 gear pump is used. This pump is a five gallons per minute, positive displacement spur gear pump, which has been fitted with a 110 V AC, ⅓ horsepower electric motor. Those skilled in the art will appreciate that various pumps may be used, so long as the pump is capable of generating sufficient suction to remove waste grease from a grease trap, and is capable of pumping the waste grease through the waste grease removal system to an outer container. The pump 120 is operatively coupled to a power supply. A power cord 130 may be connected to the pump 120 for coupling to the power supply. A power switch 135 may be connected to the system 100 and power supply for selective interruption of power, if needed.

The inlet 121 of the pump 120 is connected to and in flow communication with a suction line 126. The inlet 121 and suction line 126 guide the flow of waste grease from an intake wand/hose assembly 140 (FIG. 5) into the pump 120. The outlet 122 of the pump 120 is connected to and in flow communication with a pressure line 128. The outlet 122 and pressure line 128 guide the flow of waste grease out of the pump 120 and toward a storage container (not shown) for storage of the liquid waste grease. The suction line 126 extends from the pump 120 to a first coupling 127 mounted to a first sidewall 160 of the enclosure base 112, and the first coupling 127 extends through the first sidewall 160 to the front outside face of the outer container 110 for connection with the intake assembly 140. The pressure line 128 likewise may extend from the pump 120 to a second coupling 129, the second coupling being mounted to a second sidewall 162 of the enclosure base 112, and then may extend through the second sidewall 162 to the rear outside face of the outer container 110. Preferably, the second coupling 129 is connected to a hose barb (not shown) for connection to a pressure hose which may terminate in a waste storage container (not shown).

The intake assembly 140, illustrated in FIG. 5, draws the grease from the filter 60 disposed in the grease trap 40, and guides the grease to the suction line 126. The intake assembly 140 includes a wand 142 and a flexible hose 144. The wand 142, located at the distal end of the intake assembly 140, has an end 143 with a diameter smaller than the diameter of the opening 67 of the filter of FIGS. 2 and 3. As such, the wand may be inserted into the top of the vertical strainer tube 66.

The filter arrangement 60 remains in the grease trap 40, as illustrated in FIG. 3, as it is filled with grease and particles. The wand end 143 (FIG. 5) is then inserted into the opening 67 of the filter 60 of FIGS. 2 and 3 and the suction device is activated. As a result, the grease in the grease trap filters through the screen material that forms the horizontal and vertical strainer tubes. The solid particles remain on the external surfaces of the horizontal and vertical strainer tubes (64 and 66 in FIGS. 2 and 3).

The wand removes the grease that has filtered through the strainer tubes of the filter in the grease trap. As a result, the solid particles, such as meat particles, egg particles or carbon residue, from the grill remain in the grease trap adjacent to the exterior surfaces of the filter strainer tubes. Once the liquid waste grease has been removed, the filter may be removed from the grease trap 40 and rinsed, such as under a water facet. The rinsed-off solid particles may be deposited in a waste storage container for disposal.

In a preferred embodiment, a coupling 149 is employed to connect the intake assembly 140 with the suction line 126 of FIG. 4. Coupling 149 connects to the mating coupling 127 located on the front outside face of the outer container 110 to connect the intake assembly 140 to the suction line 126.

After the waste grease has traveled through the filter 60, wand 142, hose 144, suction line 126, pump 120, and pressure line 128, the liquid waste grease may be deposited in a waste grease storage container (not shown) coupled to the pressure line 128, preferably via the second coupling 129.

In order to prevent the waste grease from solidifying and clogging the system, a heater is employed for warming the suction line 126. It is also desirable that the heater be used to warm the pump 120, particularly the head of the pump, and the pressure line 128. If the pump 120, suction line 126, and pressure line 128 of the system are enclosed within the outer container 110 and covered by the cover 114, the system will retain heat. The heater, in a preferred embodiment, takes the form of electrical heat tape 190, preferably aluminum foil tape, which is wrapped around the suction line 126, pump 120, and pressure line 128. Alternate means of heating may be used as well, such as pad heaters. The heater is connected to a power supply, via a switch 196, for selective interruption of power, if needed. Otherwise, the heater remains on continuously. The use of a heater for heating the suction line, pump, and pressure line minimizes the chances of a malfunction of the invention due to solidification, and makes the present invention particularly well suited for the removal of waste grease. Also, cleaning of the system is simple since the heated intake assembly, suction line, pump, and pressure line are unlikely to accumulate waste grease or solid particles that may have become trapped by such accumulated waste grease within the system.

It should be noted that while the embodiment illustrated shows a filter that is removably engaged by an intake wand/hose assembly of a suction device, the present invention also covers embodiments where the filter is permanently connected to the intake wand/hose assembly or any other arrangement, such as a duct or the like, for transferring grease to the suction device. In addition, the present invention also covers embodiments where the filter is permanently installed within the grease trap.

While the preferred embodiments of the invention have been shown and described, it will be apparent to those skilled in the art that changes and modifications may be made therein without departing from the spirit of the invention, the scope of which is defined by the appended claims.

What is claimed is:

1. A filter for use in a grease trap and with a suction device, the filter comprising:
a. a first strainer tube having a plurality of apertures and an opening adapted to be removably engaged by the suction device; and
b. said first strainer tube sized to be received within said grease trap so that when the first strainer tube is positioned in the grease trap and engaged by the suction device, grease in the grease trap is filtered by the filter and removed from the grease trap by the suction device.

2. The filter of claim 1 further comprising a second strainer tube attached to and in communication with the first strainer tube.

3. The filter of claim 2 wherein said second strainer tube is attached to the first strainer tube so that the strainer tubes are generally oriented perpendicular to one another.

4. The filter of claim 3 wherein the grease trap includes a bottom and the second strainer tube is sized so that it may lay horizontally on the bottom of the grease trap.

5. The filter of claim 2 wherein said first and second strainer tubes are joined by an elbow.

6. The filter of claim 2 wherein the second strainer tube has a first end that is in communication with the first strainer tube and a second end that is closed by a cap.

7. The filter of claim 2 wherein the first and second strainer tubes are cylindrical.

8. The filter of claim 2 wherein the first and second strainer tubes are formed from polyethylene.

9. The filter of claim 1 wherein the first strainer tube is cylindrical.

10. The grease trap arrangement of claim 1, wherein the first strainer tube is formed from polyethylene.

11. The grease trap of claim 1 wherein the suction device includes a wand and the opening of the filter is sized to removably receive the wand.

12. A system for filtering and removing grease from a grease trap comprising:
a. a suction device including:
i) a pump having an inlet and an outlet;
ii) an intake assembly including a hose having a first end and a second end with the first end of the hose in communication with the inlet of the pump;
b. a filter adapted to be removably positioned within the grease trap and having an opening with which the second end of the hose may be removably placed in communication so that grease in the grease trap is removed by the suction device after being filtered by the filter.

13. The system of claim 12 wherein the filter includes a strainer tube.

14. The system of claim 13 wherein the strainer tube is cylindrical.

15. The system of claim 12 wherein the filter includes a horizontal strainer tube and a vertical strainer tube in communication with one another, wherein the opening is formed in the vertical strainer tube.

16. The system of claim 15 wherein the horizontal and vertical strainer tubes are cylindrical.

17. The system of claim 15 wherein the grease trap includes a bottom and a front wall and the horizontal strainer tube is sized to rest on the grease trap bottom with the vertical strainer tube positioned adjacent the grease trap front wall.

18. The system of claim 14 wherein the horizontal and vertical strainer tubes are joined by an elbow.

19. The waste removal system of claim 12 wherein the intake assembly of the suction device also includes a wand positioned upon the second end of the hose with said wand removably engaging the opening of the filter.

20. A method for filtering and removing grease from a grease trap comprising the steps of:
a. removably inserting a filter having an opening into the grease trap;
b. providing a suction device having a hose;
c. removably placing the hose in communication with the opening of the filter; and
d. activating the suction device so that grease is drawn through the filter and then removed from the grease trap.

21. A filter device for use in a grease trap and with a suction device, the filter device comprising:
a. a strainer tube having a plurality of apertures and an opening;
b. means for transferring grease to the suction device in communication with the opening of the strainer tube; and
c. said strainer tube sized to be received within said grease trap so that when the strainer tube is positioned in the grease trap and in communication with the suction device, grease in the grease trap is filtered by the filter and removed from the grease trap by the suction device.

22. A grease trap having a filter for use with a suction device comprising:
a. a container; and
b. a filter including a strainer tube positioned within said container, said strainer tube having a plurality of apertures and an opening adapted to be engaged by the suction device.
